(19) United States
(12) Patent Application Publication
(10) Pub. No.: US 2014/0315707 A1
(43) Pub. Date: Oct. 23, 2014

(54) Method for automatically loading a centrifuge with sample containers

(71) Applicant: ANDREAS HETTICH GMBH & CO. KG, TUTTLINGEN (DE)

(72) Inventor: Klaus-Guenter Eberle, Tuttlingen (DE)

(73) Assignee: ANDREAS HETTICH GMBH & CO. KG, TUTTLINGEN (DE)

(21) Appl. No.: 14/353,493

(22) PCT Filed: Oct. 24, 2012
(86) PCT No.: PCT/EP2012/071057

§ 371 Date: Apr. 23, 2014

(30) Foreign Application Priority Data
Oct. 24, 2011 (DE) 10 2011 054 766.5

(51) Int. Cl. B04B 5/04

(52) U.S. Cl. CPC B04B 5/0421
USPC 494/37

(57) ABSTRACT

The invention relates to a method for automatically loading a swinging bucket centrifuge with sample containers, and, the swinging bucket centrifuge being adapted to accommodate a centrifuge carrier which has a plurality of receiving pockets positioned according to a predetermined receiving pocket pattern. The invention is characterized in that the centrifuge carrier is placed in a swinging bucket, with the positioning pattern for the sample containers being determined such that the center of gravity of the moved masses will be on the centrifuge axis during centrifugation when the centrifuge buckets have assumed their swung out positions.

This patent application is the national phase entry of PCT/EP2012/071057. PCT/EP2012/071057, international application filing date Oct. 24, 2012, and claims the benefit and priority of and to German patent application no. DE 10 2011 054 766.5, filed Oct. 24, 2011. German patent application no. DE 10 2011 054 766.5, filed Oct. 24, 2011 is incorporated herein by reference hereto.

The present invention relates to a method for automatically loading a centrifuge with sample containers.

Centrifuges work using a centrifugal force generated by a uniform circular motion of a sample to be centrifuged. This principle utilizes the mass inertia of the individual components of the sample contained in a sample container in order to separate these components.

Owing to the centrifugal force acting on them, centrifuges are exposed to a high mechanical load which may have a considerable adverse effect on their service life.

Disclosed in U.S. Pat. No. 6,060,022 is a process for automatically loading a centrifuge, in particular a swinging bucket centrifuge, with sample containers. In this process, the sample containers are loaded in such a way that approximately the same weight is also obtained in the container on the opposite side of the centrifuge center relative to the centrifuge shaft. This ensures a substantially even speed of the centrifuge and avoids a certain degree of unbalance.

It is the object of the present invention to provide a method for loading a centrifuge with sample containers which will contribute to an extended service life of the centrifuge.

Known from the prior art is a method for automatically loading a swinging bucket centrifuge with sample containers, said swinging bucket centrifuge being adapted to accommodate a centrifuge carrier having a plurality of receiving pockets which are positioned relative to each other according to a predetermined pattern. The method comprises at least the following steps: Providing a plurality of sample containers each filled with a respective sample; loading said sample containers into a storage means; determining the individual weight for each of the sample containers loaded into the storage means; determining a positioning pattern for selected weighed sample containers in said at least one centrifuge carrier on the basis of the individual weights of the sample containers and the pattern of receiving pockets; loading the sample containers selected for the positioning pattern from said storage means into the receiving pockets of said at least one centrifuge carrier; and loading said centrifuge carrier into said swinging bucket centrifuge.

According to the invention, the positioning pattern is selected such that the moved masses of the sample containers holding the samples will be balanced when the swinging bucket is swung outward during centrifuging. Furthermore, the positioning pattern for the sample containers is determined such that the center of gravity of the moved masses will be on the centrifuge axis during centrifugation, when the centrifuge containers have assumed their swung out position.

For determining the positioning pattern and the corresponding placement, not only the individual weight of the sample containers will be taken into account but also their positions during centrifugation.

As the sample containers are loaded into the centrifuge carrier in such a way that the moved masses of said at least one centrifuge carrier and the sample containers filled with samples are balanced, there will basically be no unbalances during centrifuging, which will in turn reduce the mechanical load acting on the centrifuge and thus extend the service life of the centrifuge.

More specifically, the method of the present invention is a method for loading a swinging bucket centrifuge. In accordance with the present invention, for loading a swinging bucket centrifuge depending on a pattern of receiving pockets, the geometry of the centrifuge and the resulting centrifugal force acting on said sample containers during centrifugation, a positioning pattern of said sample containers within the centrifuge carrier is determined. For each sample container, the centrifugal force depends on its effective distance from the centrifuge axis.

This means that a mass distribution of the moved masses during centrifugation is predicted and a positioning pattern is selected in which the center of gravity of the centrifuged masses—when the swinging bucket is in its swung out state—is preferably on the motor shaft.

For example, depending on the maximum swing-out angle, the weight distribution during centrifugation may deviate from a loaded state with a fixed swing angle. This deviation can be relieved by the method according to the invention. Determining the weight distribution in the swung-out state allows a better balance of the centrifuge to be obtained in its loaded state of operation.

Subsequently the centrifuge carrier is loaded according to the determined positioning pattern based on the predicted mass distribution during operation of the centrifuge.

As the container carrier is inserted into a swinging bucket centrifuge, the containers will be swung into a horizontal position during centrifugation. Contrary to a fixed-angle centrifuge, a change of the center of gravity is accomplished through a change of position of the masses. Provided that the sample containers are evenly distributed when being loaded into the centrifuge, the swinging behaviour of the centrifuge buckets can be utilized to move the center of gravity away from the motor shaft. Despite a uniform distribution of the masses, this may still result in the centrifuge being unbalanced, however.

The method according to the invention for loading a swinging bucket centrifuge also allows unbalances to be avoided when a swinging bucket centrifuge is used, thus resulting in an extended service life of said centrifuge.

Centrifuges can accommodate a single centrifuge carrier centrally mounted within them, which carrier may be permanently installed or also removable, or they can accommodate a plurality of centrifuge carriers which are received in eccentrically hinged centrifuge buckets of said centrifuge. In accordance with the present invention, said centrifuge carrier can be introduced into the centrifuge before or after having been loaded with the sample containers.

Preferably a positioning pattern is also determined depending on the loads of the other centrifuge carriers which are to be centrifuged at the same time.

This will ensure a balanced load during centrifugation.

In accordance with one embodiment of the invention, the centrifuge has a plurality of centrifuge buckets which are each adapted to accommodate one of a plurality of centrifuge carriers for centrifugation, which centrifuge carriers each have a plurality of receiving pockets positioned relative to each other according to a predetermined pattern. This positioning pattern is determined for each centrifuge carrier. The sample containers selected for the respective positioning patterns are loaded from the storage means into the receiving pockets of the centrifuge carriers associated with the respective positioning patterns. The centrifuge carriers holding the sample containers are then loaded into the respective centrifuge buckets of said centrifuge in such a way that the moved masses of all the centrifuge carriers loaded into the centrifuge will be balanced with respect to each other during centrifugation in said centrifuge.

In accordance with this embodiment of the invention, each centrifuge carrier is thus loaded such that, on the one hand, it will be balanced in itself, and on the other hand, the centrifuge is loaded with the plurality of centrifuge carriers such that these carriers in turn will be balanced relative to each other. This is an optimal way of avoiding or at least reducing unbalances.

The weights and the positioning patterns are preferably determined in an electronic control device using suitably programmed software and/or firmware.

In accordance with yet another embodiment of the present invention, a sample container type is determined for each sample container in said storage means.

This is an advantageous way of drawing conclusions as to the physical properties of the respective sample container and/or the properties of the sample contained in it. For the determination of the positioning pattern, the separation behaviour which will influence the mass distribution during centrifugation may also be taken into account, for example.

In accordance with yet another embodiment of the present invention, a weight of the empty sample containers is determined from the sample container type determined.

This empty weight can advantageously be used as an additional factor when determining the respective positioning patterns. More specifically, if the empty weight is used as a calculation factor, the weight of each sample can be calculated.

In accordance with yet another embodiment of the invention, an individual prioritization is determined in the storage means for each sample held in one of the sample containers.

This advantageously allows the handling of the respective associated sample container to be controlled based on the respective prioritization.

According to an embodiment of the invention, said prioritization is performed in a particularly simple manner by detecting a color on a lid of the sample container.

According to yet another embodiment of the invention, the positioning pattern is additionally determined on the basis of the individual prioritizations meaning that higher-priority samples will be given priority over lower-priority samples.

The centrifuge carriers are loaded with samples in the order of their respective priorities. In doing so, care is taken that the weights on the carriers are balanced.

According to yet another embodiment of the invention, a rotatably mounted circular table is used as the storage means. Arranged in a predetermined zone around its diameter is a plurality of receiving units for receiving the respective sample containers.

Use of this circular table makes it possible to perform the weighing at a single position using a single weighing device, which helps reduce costs and at the same time improves the comparability and/or the precision of the weight measurements since deviations due to different weighing means can be ruled out.

Preferably, the weighing step is thus performed at a single rotary position of said circular table.

In accordance with yet another embodiment of the invention, an individual code on each sample container is simultaneously read during weighing.

Further advantages, features and possible applications of the present invention may be gathered from the description which follows, in which reference is made to the embodiment(s) illustrated in the drawings.

Throughout the description, claims and drawings, those terms and associated reference numerals are used as are contained in the list of reference numerals below.

In the drawings,

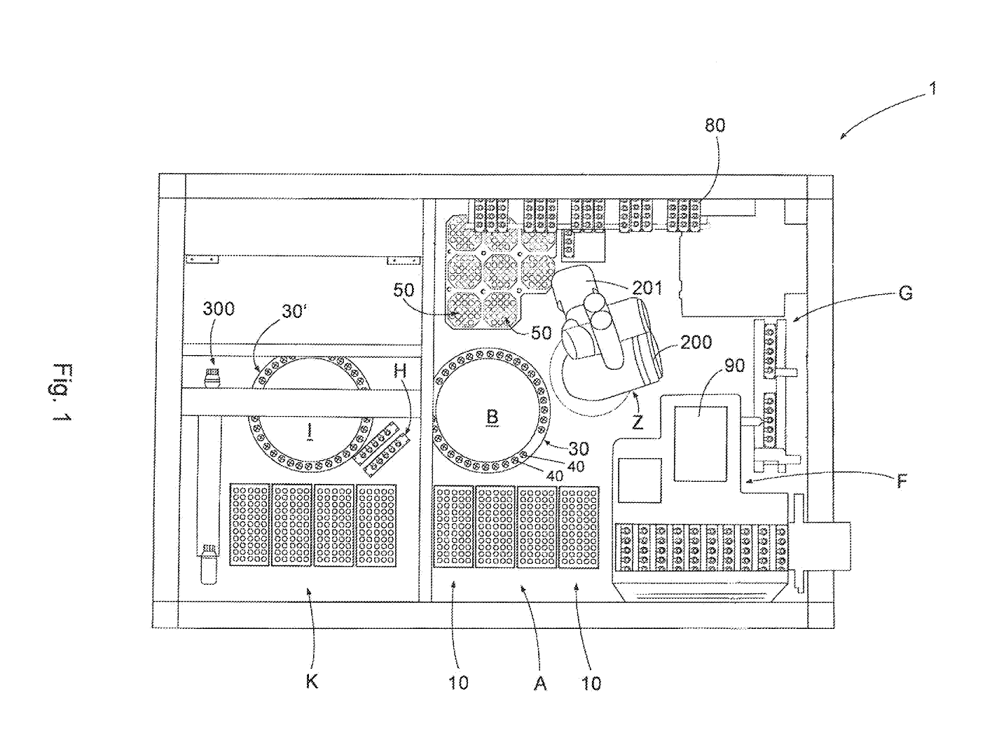

FIG. 1 is a top view of a sample processing system according to an embodiment of the invention;

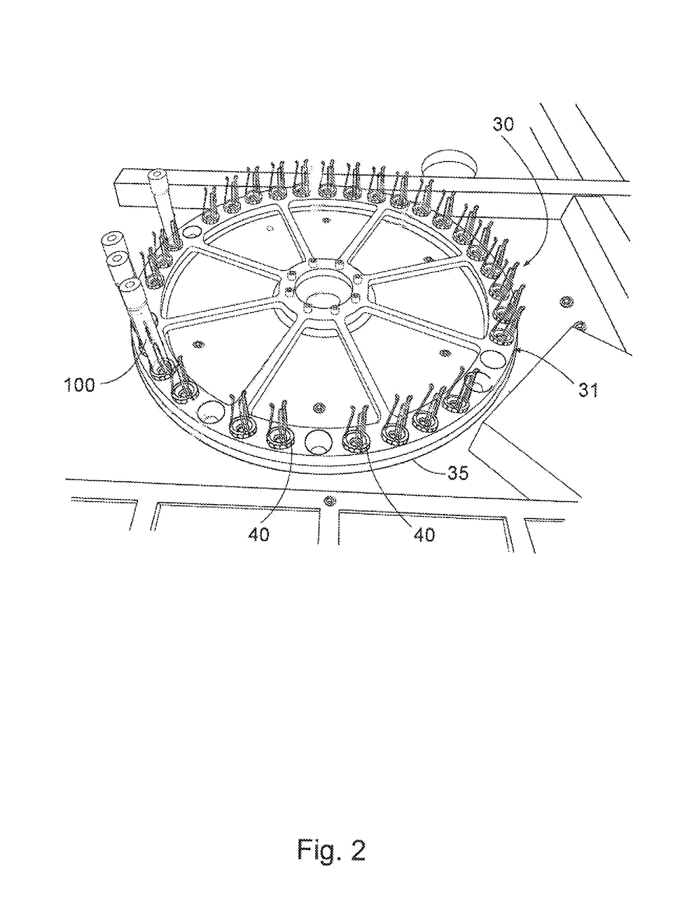

FIG. 2 is a perspective view of a circular table of said sample processing system of FIG. 1 which functions as a storage means;

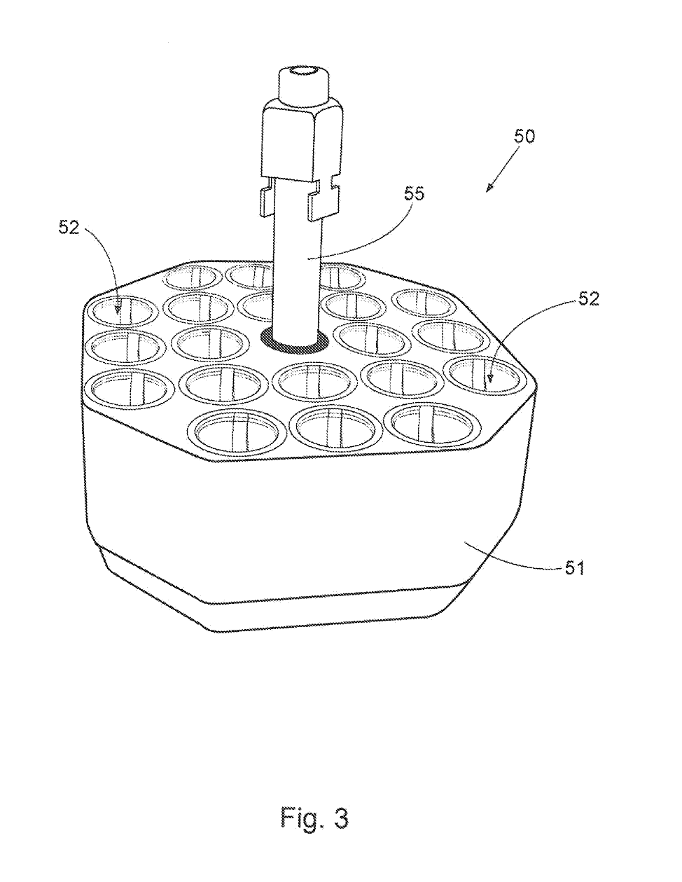

FIG. 3 is a perspective view of a centrifuge carrier of said sample processing system of FIG. 1 which serves to accommodate a plurality of sample containers;

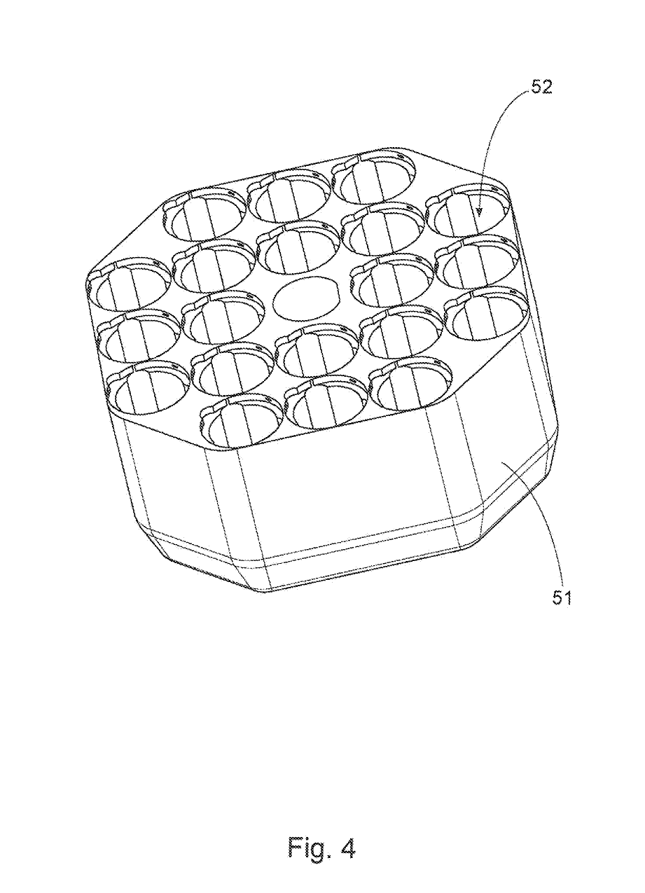

FIG. 4 is a perspective view of a carrier base of the centrifuge carrier of FIG. 3;

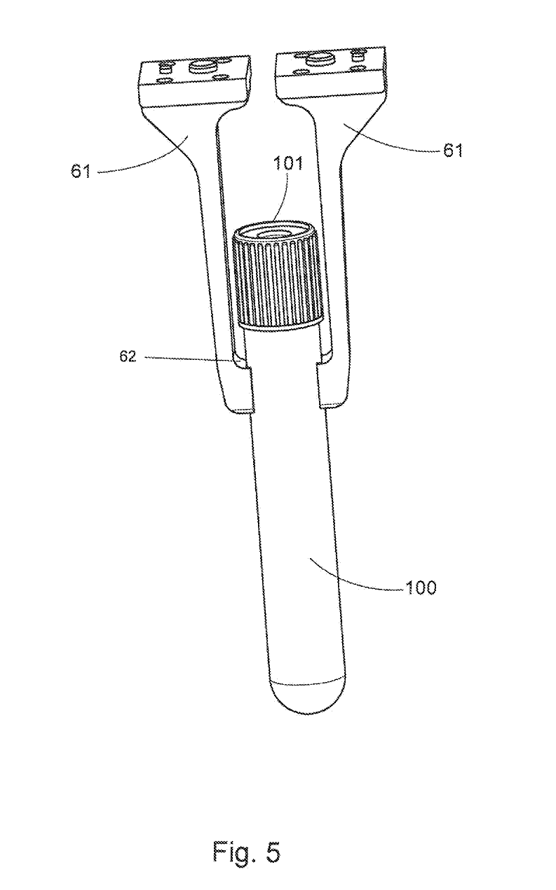

FIG. 5 is a perspective view of the two gripper fingers of the gripping means as they have just gripped a sample container;

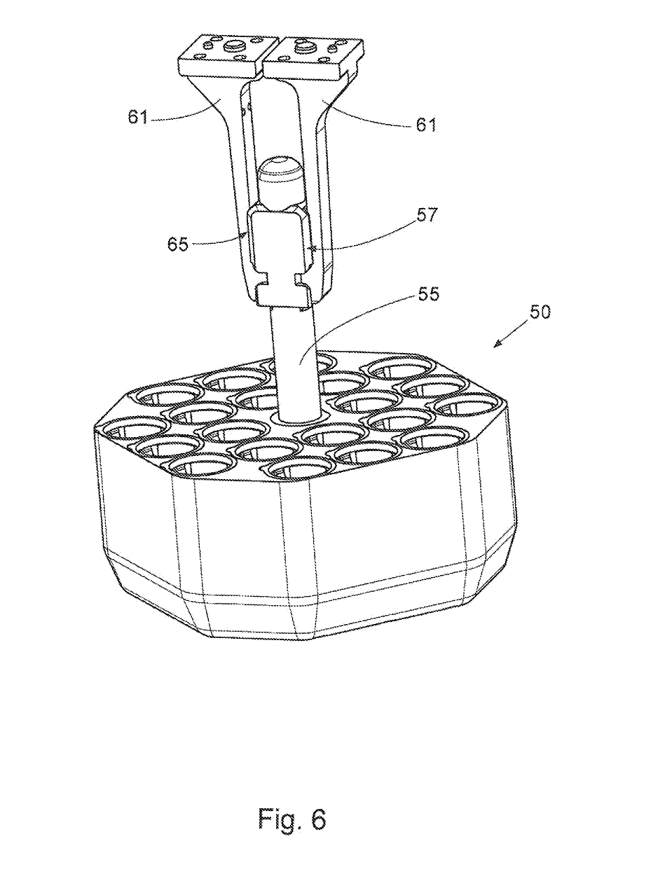

FIG. 6 is a perspective view of the two gripper fingers of the gripping means as they have just gripped the grip pin of the centrifuge carrier;

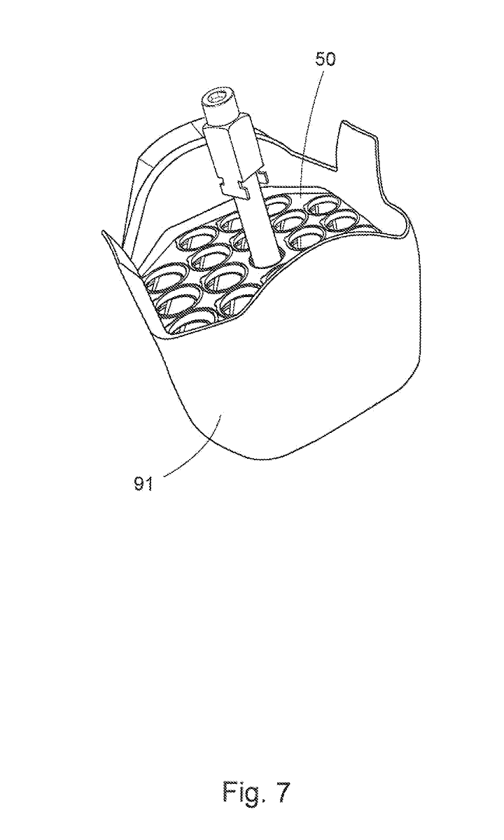

FIG. 7 is a different perspective view of a centrifuge bucket;

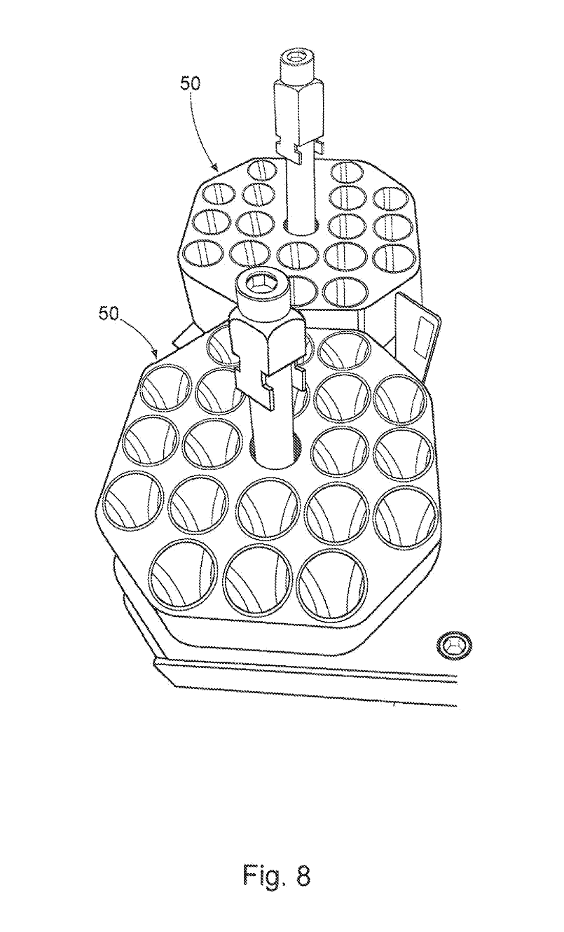

FIG. 8 is a perspective partial view of the respective portion of FIG. 1.

In the following, a sample processing system 1 according to an embodiment of the invention is described with reference to FIGS. 1 to 8.

FIG. 1 is a top view of the inventive sample processing system 1 for weighing and centrifuging the most varied types of samples.

The sample processing system 1 has an inlet storage section A, a first intermediate storage section B, a second intermediate storage section C and a centrifuging section F.

Roughly in the middle between the above mentioned sections, a first robot 200 using an articulated robot arm is disposed in a central section Z.

Located in the inlet storage section A is a plurality of receiving module arrays 10 each consisting of a plurality of receiving modules 11 and holding sample containers 100. The sample containers 100 are each preferably designed as small tubes in the form of test tubes.

In the first intermediate storage area B, a circular table 30 as shown in FIG. 2 is provided as storage means for accommodating a plurality of sample containers 100. For accommodating said sample containers 100, a corresponding number of receiving units 40 have been inserted into said circular table which will each receive a respective sample container 100.

Moreover, a circular table 30 is provided which furthermore comprises a rotary drive means (not shown) which is disposed in the second rotary area under the circular table body 31. Located in the second intermediate storage area C is a plurality of centrifuge carriers 50. A centrifuge carrier 50 of this type is shown in FIGS. 4, 6 to 8.

Provided in the central area Z is a robot 200 which has a robot arm 201 (see FIG. 1) provided with is a manipulator head (not shown) for performing pivoting and rotary motions.

Mounted on said manipulator head is a gripping means 60 according to an embodiment of the invention so as to allow the manipulator head to pivot and turn objects.

The gripper means 60 has two identical gripper fingers 61, 61 which will be described in more detail hereinafter with reference to FIGS. 5 and 6.

Located in said centrifuging area F is a centrifuge 90 which is adapted for centrifuging the samples held in said sample containers 100.

The centrifuge 90 has one or plural centrifuge buckets 91 (see FIG. 7) which is/are in particular pivotably (not shown) hinged on the one rotor of the centrifuge. Each centrifuge bucket 91 is adapted to receive one of said centrifuge carriers 50 (FIG. 3, FIG. 4) for centrifuging. A centrifuge bucket 91 of this type is only schematically shown in FIG. 7. For further details regarding a possible design of the centrifuge bucket 91, reference is made to DE 10 2009 015 111 A1.

As can be seen from FIG. 3, the centrifuge carrier 50 has a carrier base 51 and a grip pin 55 mounted on said carrier base 51. The centrifuge carrier may be gripped by said gripper fingers 61 at the upper end of said grip pin 55.

Provided in said carrier base 51 is a plurality of receiving pockets 52 arranged relative to each other in a predetermined pattern and adapted to accommodate sample containers 100.

Methods for operating the sample processing system 1 of the present invention as well as its manner of operation will now be described with reference to the drawings.

The sample containers 100 are first introduced into the receiving modules 11 which are interconnected to form receiving module arrays 10 each capable of receiving fifty sample containers 100. Once filled, said receiving module arrays 10 will be forwarded to the inlet storage area A of said sample processing system 1. All sample containers 100 have a code (preferably a bar code) and a lid 101.

Next, said gripper fingers 61 of a gripping means of the robot 200 disposed in the central area Z will grip the sample containers 100 one after the other with their respective first gripper portion 62 (as shown in FIG. 5), placing said sample containers 100 one at a time on a circular table 30 until said circular table 30 is completely loaded with sample containers 100.

For this purpose, the gripper fingers 61 of the gripping means have their respective first gripping area 62 shaped to fit the shape of the sample container 100.

The circular table 30 incrementally rotates by a certain rotary angle which corresponds to the angular distance of two adjacent receiving units 40. In the course of rotation of said circular table 30, all receiving units 40 will at some stage reach a second rotary range of said guide 35.

In the second rotary range of the guide 35 of said circular table 30 there is a weighing means. At said weighing means, the respective sample container 100 will be lifted slightly together with the receiving unit 40 and turned around its longitudinal axis. As the sample container is being turned, the code on the sample container 100 will be read. Since the sample container 100 is lifted together with the receiving unit 40, this makes it easy to weigh said sample container 100. It is also made sure that neither the sample container 100 nor the receiving unit 40 rest on any surface as this would falsify the weighing result

Provided at the weighing means is the optical detection means (preferably a camera) of said first circular table 30 which is adapted to detect the type of the sample container 100 and the color of its lid 101. The color of the container lid 101 indicates the prioritization of the sample. Detecting the sample container type is also of interest concerning the weight of the (empty) sample containers 100 as different types of sample containers 100 may also differ in weight.

Once the first circular table has been completely loaded with sample containers, loading of the centrifuge carriers 50 located in the second intermediate storage area C with weighed and detected sample containers 100 from the first circular table 30 begins. For this purpose, after weighing the sample containers 100 and before loading them into the centrifuge carriers 50, an automatic evaluation is performed in an electronic control means (not shown) to determine where the individual sample containers 100 are to be placed in a respective centrifuge carrier 50 for centrifuging so as to ensure a balanced weight within said centrifuge 90.

Against the background of the operation of said sample processing system 1, a method according to the present invention for loading said centrifuge 90 with sample containers 100 will now be described.

In accordance with this method, at the least the following steps are performed:
Providing a plurality of sample containers 100 each holding respective samples;
loading said sample containers 100 into said circular table 30 which serves as a storage means;
weighing each sample container 100 on said first circular table 30 and determining the individual weight of each sample container 100 loaded into the circular table 30 (which weighing step is preferably performed at a single rotary position of said circular table 30);
determining a positioning pattern of selected weighed sample containers 100 in one of said centrifuge carriers 50 on the basis of the individual weights of the sample containers 100 and of the receiving pocket pattern of the centrifuge carrier 50 so as to ensure that the moved masses of said centrifuge carrier 50 and of the sample containers 100 holding the samples will be balanced during centrifuging in said centrifuge 90;
loading those sample containers 100 which were selected for the positioning pattern from said circular table 30 and into the receiving pockets 52 of said centrifuge carrier 50; and
loading the centrifuge carrier 50 holding said sample containers 100 into a centrifuge bucket 91 of said centrifuge 90.

If, as is preferred, said centrifuge 90 has a plurality of centrifuge buckets 91 which are each adapted to accommodate one of said centrifuge carriers 50 for centrifuging, then the following steps are performed:
Determining the positioning pattern for each of said centrifuge carriers 50;
loading the sample containers 100 selected for the respective positioning patterns from said first circular table 30 and into the receiving pockets 52 of the centrifuge carriers 50 associated with the respective positioning patterns; and
loading the centrifuge carriers 50 each holding sample containers 100 into the respective centrifuge buckets 91 of said centrifuge 90 in such a way that the moved masses of all the centrifuge carriers 50 loaded into said centrifuge 90 will be balanced relative to each other during centrifuging in said centrifuge 90.

Selection of the positioning patterns by the control unit will be as described hereinafter.

In accordance with the present invention, for loading a swinging bucket centrifuge depending on a receiving pocket pattern, the geometry of the centrifuge and the resulting centrifugal force acting on the sample containers during centrifugation, a positioning pattern of the sample containers in the centrifuge carrier will be determined. For each sample container, the centrifugal force depends on its effective distance from the centrifuge axis.

The significant advantages of a balanced loading of said centrifuge 90 are a consistent centrifugation quality level throughout various samples and a longer service life of the centrifuge 90.

As already mentioned above, the sample container type is determined for each sample container 100 in the circular table 30, and the determined sample container type is then used to determine the weight of the empty sample container 100.

As likewise mentioned above, in said circular table 30, an individual prioritization is determined for each sample contained in one of the sample containers 100, which prioritization is determined by detecting a color of the lid 101 of said sample container 100. As also mentioned above, during weighing, the individual code (bar code) on each sample container 100 will also be read at the same time.

According to the invention, the one or plural positioning pattern(s) may additionally be determined on the basis of the individual prioritizations meaning that higher-priority samples will be given priority over lower-priority samples.

As a summary, in the method according to the invention, the sample containers 100 are first temporarily stored on the circular table 30 where they are also weighed. Additionally, the color or gray level of the lid 101 of each sample container 100 may be detected there which specifies the type of the sample container 100.

Depending on the weight of the sample, the sample containers 100 are then positioned in the centrifuge carriers 50 for the centrifuge 90. More specifically, the sample containers 100 are arranged within the centrifuge carrier 50 in such a way and so as to ensure that the moved masses will be balanced during centrifuging in the centrifuge 90 with the centrifuge carriers 50 with the sample containers 100 holding the samples. The weight of the sample containers 100 with the samples is first detected and then the sample containers 100 are positioned within the respective centrifuge carrier 50 and the centrifuge carrier 50 is positioned within the centrifuge 90 in such a manner that the moved masses will be balanced.

As ensues from the above, once loading of the centrifuge carriers 50 for the centrifuge 90 has been completed, the gripping means will grip each of the loaded centrifuge carriers 50 and place it in one of the centrifuge buckets 91, as shown in FIG. 7.

The gripper fingers 61, 61 of the gripping means 60 will grip, via their respective first and second gripping areas 62 and 65, the grip pin 55 of the respective centrifuge carrier 50 at its second contact surface 57, as is shown in FIG. 6.

Once the centrifuge carrier 50 has been placed in the centrifuge bucket 91, the loading operation has been completed.

### LIST OF REFERENCE SIGNS

1 sample processing system
10 receiving module array
30 circular table
31 circular table body
35 guide
40 receiving unit
50 centrifuge carrier
51 carrier base
52 receiving pocket
55 grip pin
57 second contact surface
61 gripper finger
62 first gripping area
65 second gripping area
80 sample container carrier
91 centrifuge bucket
100 sample container
101 lid
A inlet storage area
F centrifuging area
G lid-removing area
K outlet storage area

1-10. (canceled)

11. A method for automatically loading a swinging bucket centrifuge (90) with sample containers (100), said swinging bucket centrifuge (90) being adapted to accommodate a centrifuge carrier (50) in it which has a plurality of receiving pockets (52) arranged in a predetermined receiving pocket pattern, said method comprising the following steps:
providing a plurality of sample containers (100) each holding a respective sample;
loading said respective sample containers (100) into storage means (30);
determining an individual weight for each sample container (100) loaded into said storage means (30);
determining a positioning pattern of selected sample containers (100) within at least one centrifuge carrier (50) on the basis of individual weights of said sample containers (100) and said receiving pocket pattern so that during centrifuging moved masses of said sample containers (100) filled with samples of said at least one centrifuge carrier (50) will be balanced;
loading said sample containers (100) selected for said receiving pocket pattern from said storage means (30) into said receiving pockets (52) of said at least one centrifuge carrier (50); and
loading said centrifuge carrier (50) into said centrifuge (90),
said centrifuge carrier (50) is placed in a swinging bucket;
said receiving pocket pattern for said sample containers (100) determined such that the center of gravity of said moved masses is on the centrifuge axis during centrifugation when said centrifuge buckets (91) are in their swung out position.

12. The method as claimed in claim 11 wherein:
said centrifuge (90) has a plurality of centrifuge buckets (91);
each of said centrifuge buckets adapted to accommodate one of a plurality of centrifuge carriers (50);
each of said receiving pockets (52) positioned relative to each other in said predetermined receiving pocket pattern of said centrifuge carriers;
said receiving pocket positioning pattern is individually determined for each centrifuge carrier (50);
said sample containers (100) selected for a receiving pocket of a respective receiving pocket positioning pattern are taken out of said storage means (30) and loaded into said receiving pockets (52) of said centrifuge carrier (50);
said centrifuge carriers (50) are each loaded with said sample containers (100) loaded into said respective centrifuge buckets (91) of said centrifuge (90) in such a way that during centrifuging in said centrifuge (90) said moved masses of all of said centrifuge carriers (50) loaded into said centrifuge (90) are balanced with respect to each other.

13. The method as claimed in claim 11, wherein in said storage means (30) a sample container type is determined for each sample container (100).

14. The method as claimed in claim 12, wherein in said storage means (30) a sample container type is determined for each sample container (100).

15. The method of claim 13 wherein from the determined type of sample container a weight of said type of sample container (100) is determined when it is empty.

16. The method of claim 14 wherein from the determined type of sample container a weight of said type of sample container (100) is determined when it is empty.

17. The method of claim 11 wherein in said storage means (30) an individual prioritization is determined for each sample contained in one of said sample containers (100).

18. The method of claim 12 wherein in said storage means (30) an individual prioritization is determined for each sample contained in one of said sample containers (100).

19. The method of claim 11 wherein said prioritization is determined by detecting a color of a lid (101) of said sample container (100).

20. The method of claim 12 wherein said prioritization is determined by detecting a color of a lid (101) of said sample container (100).

21. The method of claim 17 wherein said receiving pocket positioning pattern is additionally determined on the basis of the individual prioritizations meaning that high-priority samples will be given priority over lower-priority samples.

22. The method of claim 18 wherein said receiving pocket positioning pattern is additionally determined on the basis of the individual prioritizations meaning that high-priority samples will be given priority over lower-priority samples.

23. The method of claim 19 wherein said receiving pocket positioning pattern is additionally determined on the basis of the individual prioritizations meaning that high-priority samples will be given priority over lower-priority samples.

24. The method of claim 20 wherein said receiving pocket positioning pattern is additionally determined on the basis of the individual prioritizations meaning that high-priority samples will be given priority over lower-priority samples.

25. The method of claim 11 wherein a rotatable circular table is used as storage means (30) which has a plurality of receiving units (40) for receiving the respective sample containers (100) which are arranged along a predetermined perimeter thereof

26. The method of claim 12 wherein a rotatable circular table is used as storage means (30) which has a plurality of receiving units (40) for receiving the respective sample containers (100) which are arranged along a predetermined perimeter thereof

27. The method of claim 25 wherein the weighing is performed at a single rotary position of said circular table.

28. The method of claim 11 wherein during weighing, an individual code provided on each said sample container (100) is read at the same time.

29. A method for automatically loading a swinging bucket centrifuge (90) with sample containers (100), said swinging bucket centrifuge (90) being adapted to accommodate a centrifuge carrier (50) in it which has a plurality of receiving pockets (52) arranged in a predetermined receiving pocket pattern, said method comprising the following steps:
providing a plurality of sample containers (100) each holding respective samples;
loading said sample containers (100) into a circular table (30) which serves as a storage means;
weighing each said sample container (100) on said first circular table (30) and determining the individual weight of each sample container (100) loaded into said circular table (30), said weighing step is preferably performed at a single rotary position of said circular table (30);
determining a positioning pattern of selected weighed sample containers (100) in one of said centrifuge carriers (50) on the basis of the individual weights of the sample containers (100) and of the receiving pocket pattern of the centrifuge carrier (50) so as to ensure that the moved masses of said centrifuge carrier (50) and of said sample containers (100) holding said samples will be balanced during centrifuging in said centrifuge (90);
loading said sample containers (100) which were selected for said positioning pattern from said circular table (30) and into said receiving pockets (52) of said centrifuge carrier (50); and,
loading said centrifuge carrier (50) holding said sample containers (100) into a centrifuge bucket (91) of said centrifuge (90).

30. A method for automatically loading a swinging bucket centrifuge (90) with sample containers (100), said swinging bucket centrifuge (90) being adapted to accommodate a centrifuge carrier (50) in it which has a plurality of receiving pockets (52) arranged in a predetermined receiving pocket pattern, said method comprising the following steps:
said centrifuge (90) has a plurality of centrifuge buckets (91) which are each adapted to accommodate one of said centrifuge carriers (50) for centrifuging;
determining the positioning pattern for each of said centrifuge carriers (50);
loading said sample containers (100) selected for the respective positioning patterns from said first circular table (30) and into the receiving pockets (52) of the centrifuge carriers (50) associated with the respective positioning patterns; and
loading said centrifuge carriers (50) each holding sample containers (100) into said respective centrifuge buckets (91) of said centrifuge (90) in such a way that the moved masses of all said centrifuge carriers (50) loaded into said centrifuge (90) will be balanced relative to each other during centrifuging in said centrifuge (90).
